(19) United States
(12) Patent Application Publication
(10) Pub. No.: US 2003/0072274 A1
(43) Pub. Date: Apr. 17, 2003

(54) Transmission power setting method, a mobile communications system, and a base station

(75) Inventors: Toshiyuki Futakata, Yokosuka-shi (JP); Takayuki Ishiguro, Yokosuka-shi (JP); Sung Uk Moon, Yokosuka-shi (JP); Mayu Yamada, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NTT DoCoMo, Inc, Tokyo (JP)

(21) Appl. No.: 10/270,644

(22) Filed: Oct. 16, 2002

(30) Foreign Application Priority Data
Oct. 17, 2001 (JP) 2001-319347

(51) Int. Cl. G08C 17/00; H04J 3/00

(52) U.S. Cl. 370/311; 370/280; 370/234

(57) ABSTRACT

The mobile communication system for communications between a base station and a mobile station, employing a TDD method, sets up transmission power of the base station for each of downlink time slots that are to be transmitted next, based on receiving quality of downlink time slots that have been received by the mobile station immediately prior to transmitting the next time slots, and based on receiving power level of uplink time slots that are received by the base station.

### BACKGROUND OF THE INVENTION

1. Field of the Invention

The present invention relates to a method for setting up transmission power of a downlink time slot that is assigned to a downlink circuit from a base station to a mobile station in a mobile communications system that adopts a TDD (Time Division Duplex) method, and includes a base station and a mobile station.

2. Description of the Related Art

In a conventional mobile communications system that adopts the TDD method, a time slot is assigned alternately to each of an uplink from the mobile station to the base station, and a downlink in the opposite direction.

The base station is required to set up an appropriate transmission power such that the transmissions in the time slot assigned to the downlink circuit (hereinafter, called the downlink time slot) is surely received by the mobile station.

FIG. 6 is for explaining a first conventional method of setting up the transmission power of the downlink time slot. In the first conventional method, the mobile station extracts receiving quality of the downlink time slot (a ratio of power of a desired signal to power of interference signals, a bit error rate, a block error rate, and the like), when receiving the downlink time slot from the base station (Step 1).

Next, when the mobile station determines that the receiving quality is not fulfilling predetermined quality, the mobile station requests the base station to increase the transmission power. Conversely, when the mobile station determines that the receiving quality is excessively higher than the predetermined quality, the mobile station requests the base station to decrease the transmission power. A request to increase or decrease the transmission power (TPC: Transmission Power Control) is contained in the time slot assigned to the uplink circuit (hereinafter called uplink time slot), and transmitted to the base station (Step 2).

When the base station receives the uplink time slot containing the transmission power control information from the mobile station (Step 3), the base station adjusts the transmission power of a subsequent downlink time slot accordingly (Step 4).

FIG. 7 is for explaining a second conventional method for setting up the transmission power of the downlink time slot. Here, the base station includes a plurality of antennas, each of which is capable of both receiving and transmitting, such that space diversity is provided.

In the second conventional method, the base station receives the uplink time slot from the mobile station with the plurality of the antennas, and determines receiving power of the uplink time slot received through each of the antennas (Step 1). Next, based on the receiving power through each antenna, the base station determines weight of each antenna, and transmits a subsequent downlink time slot at transmission power that corresponds to the weight of each antenna (Step 2).

In a W-CDMA (Wide-band Code Division Multiple Access)-TDD mobile communications system that employs a W-CDMA-TDD method, a plurality of downlink time slots can be contiguously assigned between a preceding uplink time slot and a subsequent uplink time slot, while a downlink time slot and an uplink time slot have to be alternately assigned in the TDD system described above.

If the first conventional method mentioned above is applied to setting up the transmission power of the downlink time slot in the W-CDMA system, the base station will set up the same transmission power for all the time slots contiguously assigned, even if the receiving quality may be different from time slot to time slot. This is because only one piece of transmission power control information can be contained in an uplink time slot in the present (conventional) specification.

If the second conventional method mentioned above is applied to setting up the transmission power of the downlink time slot in the W-CDMA system, the same transmission power will be set up for all the time slots contiguously assigned as far as an antenna is concerned, even if the receiving quality may be different from time slot to time slot. The power may be different from antenna to antenna, according to the weight, however.

### SUMMARY OF THE INVENTION

Accordingly, in order to solve the problem mentioned above, the object of the present invention is to offer a transmission power setting method, a mobile communication system and a base station that substantially obviate one or more of the problems caused by the limitations and disadvantages of the related art, and realize appropriate setting of transmission power of each time slot individually, when a plurality of time slots are contiguously assigned for a downlink circuit.

Features and advantages of the present invention will be set forth in the description that follows, and in part will become apparent from the description and the accompanying drawings, or may be learned by practice of the invention according to the teachings provided in the description. Objects as well as other features and advantages of the present invention will be realized and attained by the method, the mobile communications system, and the base station particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides the transmission power setting method, the mobile communications system, and the base station, which are configured as follows.

The transmission power for each of downlink time slots contiguously assigned that are to be transmitted in the immediate future is set up based on one of or any combination of:

average receiving quality of downlink time slots contiguously assigned that are received by the mobile station immediately prior to transmitting the next time slots contiguously assigned, wherein the average receiving quality may be a weighted average, each of the time slots contiguously assigned being attached with a weighting factor, further the receiving quality may include a bit error rate, a block error rate, and the like;

in the case that there are contiguous uplink time slots, average receiving power of contiguous uplink time slots that are received by the base station, wherein the average receiving power may be a weighted average, each of the time slots contiguously assigned being attached with a weighting factor, the average receiving power being obtained, and corresponding transmission power being set up, for each of antennas where there are a plurality of antennas, each of which is capable of receiving and transmitting;

a time lapse between a point in time when the average receiving quality is obtained and a point in time when each of the next downlink time slots contiguously assigned is transmitted, wherein the longer the time lapse is, the higher the transmission power is set up;

a time lapse between a point in time when the average receiving power is obtained and a point in time when each of the next downlink time slots contiguously assigned is transmitted, wherein the longer the time lapse is, the higher the transmission power is set up; and

fading frequency of the communication link between the base station and the mobile station, wherein the higher the fading frequency is, the higher the transmission power is set up.

The above transmission power setting up method can be applied where an initial predetermined transmission power value is set up. That is, the initial transmission power is adjusted according to the transmission power that is obtained in the manner described above.

Accordingly, the present invention realizes the transmission power setting up for each of the downlink time slots to be transmitted next.

### BRIEF DESCRIPTION OF THE DRAWINGS

FIG. 1 shows an example of a mobile communications system of the present invention;

FIG. 2 is a block diagram of an example of a mobile station of the present invention;

FIG. 3 is a block diagram of an example of a base station of the present invention;

FIG. 4 shows relations between control delay time and required transmission power sufficient to provide predetermined receiving quality, with fading frequency being a parameter, considered in the present invention;

FIG. 5 shows a sequence of operations of the mobile station and the base station of the present invention;

FIG. 6 is for explaining the first conventional method of setting transmission power of a downlink time slot; and

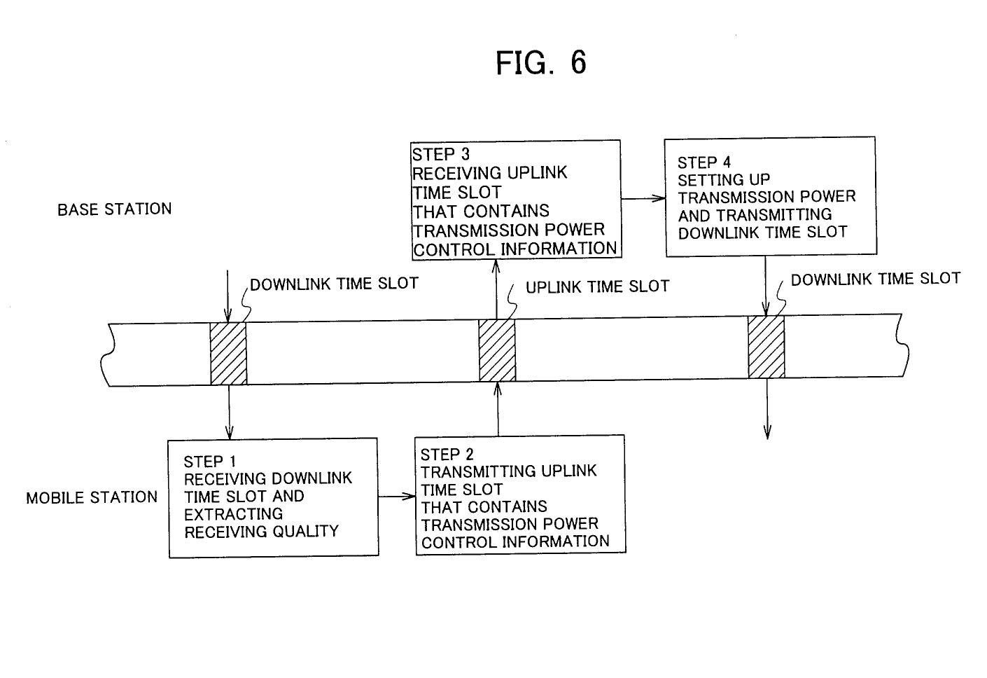

FIG. 7 is for explaining the second conventional method of setting transmission power of a downlink time slot.

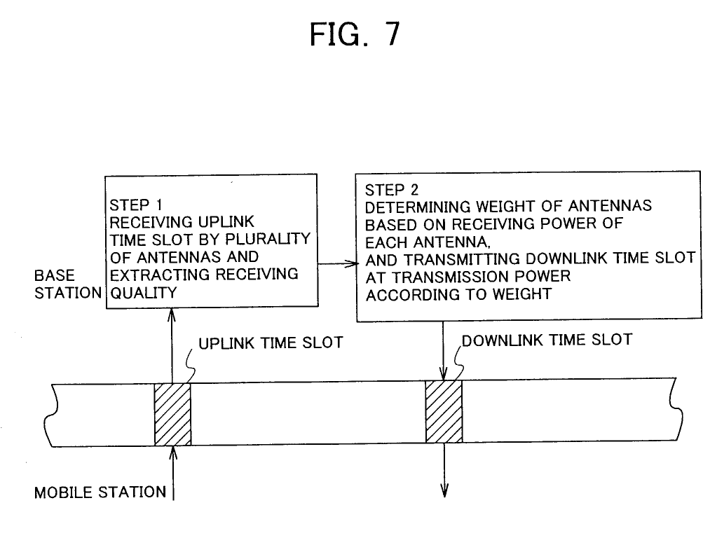

### DESCRIPTION OF THE PREFERRED EMBODIMENTS

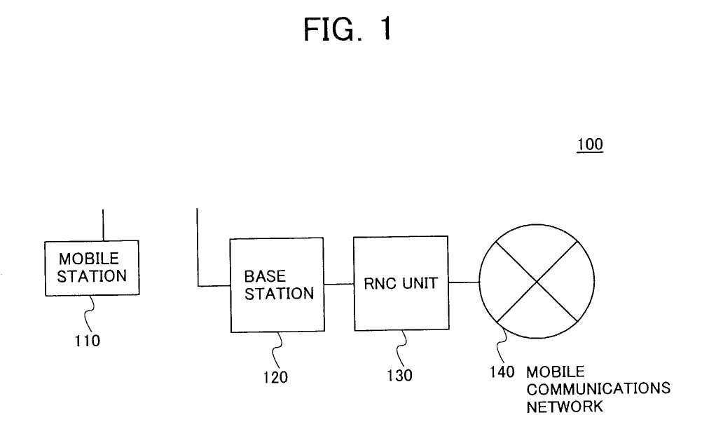

In the following, embodiments of the present invention will be described with reference to the accompanying drawings. FIG. 1 shows an example of a mobile communications system concerning the embodiments of the present invention. The mobile communications system 100 shown in FIG. 1 includes a mobile station 110, such as a cellular telephone terminal, a base station 120, a radio network control unit (RNC) 130 that controls the whole mobile communications system, and a mobile communications network 140.

In the mobile communications system 100, a TDD method is adopted for communications between the base station 120 and the mobile station 110, and time slots are asymmetrically assigned to each of an uplink circuit that serves traffic from the mobile station 110 to the base station 120, and a downlink circuit that serves traffic from the base station 120 to the mobile station 110. In the asymmetric assignment of the time slots, the number of the time slots contiguously assigned to the uplink circuit may be different from the number of the time slots contiguously assigned to the downlink circuit. For example, three downlink time slots can be contiguously assigned and transmitted with one uplink time slot preceding and another uplink time slot following.

In the mobile communications system 100, transmission power of each of the time slots that are to be contiguously assigned to the downlink circuit is decided based on factors such as the latest receiving quality measured by the mobile station 110 of the downlink time slots that are contiguously assigned to the downlink circuit, the latest receiving power measured by the base station 120 of one or more uplink time slots assigned to the uplink circuit, control delay time, and fading frequency of the communications between the mobile station 110 and the base station 120, as described in detail later.

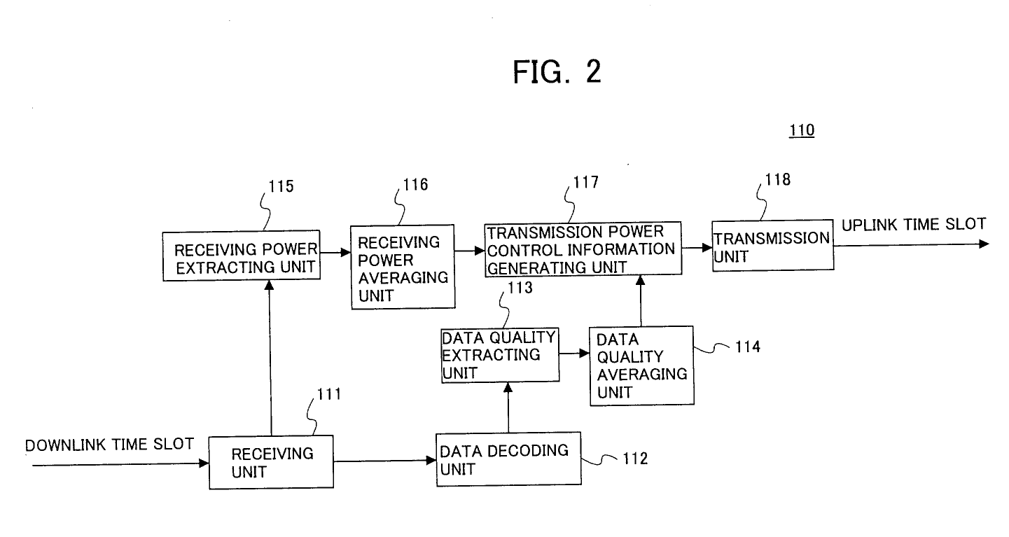

FIG. 2 is a block diagram of an example of the mobile station 110. As shown in FIG. 2, the mobile station 110 includes a receiving unit 111, a data decoding unit 112, a data quality extracting unit 113, a data quality averaging unit 114, a receiving power extracting unit 115, a receiving power averaging unit 116, a transmission power control information generating unit 117, and a transmitting unit 118.

The receiving unit 111 receives a plurality of time slots that the base station 120 contiguously transmits on the downlink circuit. The downlink time slots received by the receiving unit 111 are provided to the data decoding unit 112 and the receiving power extracting unit 115.

The data decoding unit 112 decodes each of the plurality of the time slots provided from the receiving unit 111, the time slots being contiguously assigned to the downlink circuit. In the case that the mobile communications system 100 adopts a CDMA (code-division-multiple-access) method, for example, the data decoding unit 112 decodes data by reverse diffusion using a predetermined diffusion code.

The data quality extracting unit 113 extracts data quality values (a bit error rate, a block error rate, and the like) of each of the plurality of the time slots contiguously assigned to the downlink circuit, based on the data (decoded data) decoded by the data decoding unit 112.

The data quality averaging unit 114 averages the data quality values of the plurality of the time slots, which are extracted by the data quality extracting unit 113.

The averaged data quality value is provided to the transmission power control information generating unit 117. Here, it is conceivable that the last time slot of the downlink time slots contiguously assigned better represents the latest communication path conditions, rather than the earlier time slots. For this reason, before the averaging takes place, lighter weight is attached to the quality value of earlier time slots, and heavier weight is attached to the quality value of later time slots. In other words, the data quality averaging unit 114 assigns heavier weight to time slots that are received later, such that time slots that are closer to the subsequent time slots contribute more heavily to the calculation of the average value.

The receiving power extracting unit 115 extracts receiving power of each of the time slots that are contiguously assigned to the downlink circuit, the time slots being provided from the receiving unit 111. Then, the receiving power extracting unit 115 calculates a signal-to-noise ratio (S/N ratio) of each time slot, based on the extracted receiving power.

The receiving power averaging unit 116 averages the receiving power and the S/N ratio of all the time slots that are provided by the receiving power extracting unit 115.

As described above, as for the plurality of downlink time slots received, the later a time slot is received, the closer the time slot is to subsequent time slots to be transmitted. For this reason, the receiving power averaging unit 116 may assign heavier weight to the receiving power and an S/N ratio of the later time slots, in averaging operations. The averaged receiving power and the averaged S/N ratio are provided to the transmission power control information generating unit 117.

The transmission power control information generating unit 117 generates transmission power control information as a request for the transmission power of the time slots that are to be contiguously transmitted subsequently, based on the averaged data quality provided from the data quality averaging unit 114, and the averaged receiving power and the averaged S/N ratio that are provided from the receiving power averaging unit 116.

Specifically, the transmission power control information generating unit 117 requests that the transmission power be raised when the averaged data quality and the averaged S/N ratio are not fulfilling predetermined quality, or when the averaged receiving power is not fulfilling the predetermined power level. On the other hand, the transmission power control information generating unit 117 requests that the transmission power be lowered when the averaged data quality and the averaged S/N ratio are excessively better than the predetermined quality, or when the averaged receiving power is excessively higher than the predetermined power level. In the following, the data quality, the S/N ratio, and the receiving power, all combined, are called “receiving quality”.

The transmission power control information generated by the transmission power control information generating unit 117 is provided to the transmitting unit 118. The transmitting unit 118 modulates the transmission power control information generated by the transmission power control information generating unit 117, which is contained in an uplink time slot, and transmitted to the base station 120.

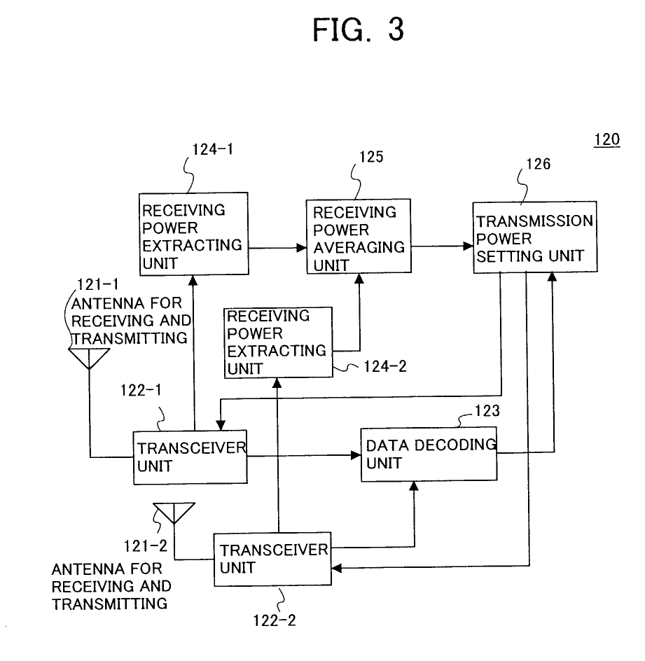

FIG. 3 is a block diagram of an example of the base station 120. The base station 120 shown in FIG. 3 includes antennas for both receiving and transmitting 121-1 and 121-2, transceiver units 122-1 and 122-2, a data decoding unit 123, receiving power extracting units 124-1 and 124-2, a receiving power averaging unit 125, and a transmission power setting unit 126. The base station 120 is an example of a diversity configuration with the two antennas 121-1 and 121-2, wherein the transceiver units 122-1 and 122-2, and the receiving power extracting units 124-1 and 124-2 are provided corresponding to the antennas 121-1 and 121-2, respectively.

The antenna 121-1 and the transceiver unit 122-1 receive one or more uplink time slots that are contiguously assigned and transmitted from the mobile station 110. The uplink time slots received by the antenna 121-1 and the transceiver unit 122-1 are provided to the data decoding unit 123 and the receiving power extracting unit 124-1.

Similarly, the antenna 121-2 and the transceiver unit 122-2 receive one or more uplink time slots that are contiguously assigned and transmitted from the mobile station 110. The uplink time slots received by the antenna 121-2 and the transceiver unit 122-2 are provided to the data decoding unit 123 and the receiving power extracting unit 124-2.

The data decoding unit 123 decodes each of the one or more uplink time slots, which are contiguously assigned, provided from the transceiver units 122-1 and 122-2. Transmission power control information is included in the data that is decoded by the data decoding unit 123. The data decoding unit 123 extracts the transmission power control information from the decoded data, and provides the transmission power control information to the transmission power setting unit 126.

The receiving power extracting unit 124-1 extracts a receiving power value of each of the uplink time slots provided from the transceiver unit 122-1. The receiving power averaging unit 125 averages the receiving power values of the time slots, the values being extracted by the receiving power extracting unit 124-1. The average of the receiving power values is provided to the transmission power setting unit 126.

Similarly, the receiving power extracting unit 124-2 extracts a receiving power value of each of the uplink time slots provided from the transceiver unit 122-2. The receiving power averaging unit 125 averages the receiving power values of the time slots, the values being extracted by the receiving power extracting unit 124-2. The average of the receiving power values is provided to the transmission power setting unit 126.

Based on the transmission power control information provided from the data decoding unit 123, and the averaged receiving power value provided from the receiving power averaging unit 125, the transmission power setting unit 126 sets up transmission power of subsequent downlink time slots that are contiguously assigned and to be transmitted through each of the antenna 121-1 and the antenna 121-2.

Specifically, when the transmission power control information provided from the data decoding unit 123 requests that the transmission power be raised, the transmission power setting unit 126 increases the transmission power of the subsequent time slots that are contiguously assigned. Conversely, when the transmission power control information provided from the data decoding unit 123 requests that the transmission power be lowered, the transmission power setting unit 126 decreases the transmission power of the subsequent time slots that are contiguously assigned.

Then, the transmission power setting unit 126 distributes the power value that is either increased or decreased in the manner described above between power of the subsequent downlink time slots to be transmitted from the antenna 121-1 and power of the subsequent downlink time slots to be transmitted from the antenna 121-2, based on the ratio of the averaged receiving power value corresponding to the antenna 121-1 to the averaged receiving power value corresponding to the antenna 121-2, the power values being provided from the receiving power averaging unit 125. For example, if the ratio of the averaged receiving power corresponding to the antenna 121-1 to the averaged receiving power corresponding to the antenna 121-2 is 2:1, the transmission power setting unit 126 allocates the transmission power such that the ratio of the transmission power of the subsequent time slots transmitted from the antenna 121-1 to the transmission power of the subsequent time slots transmitted from the antenna 121-2 is set to 2:1.

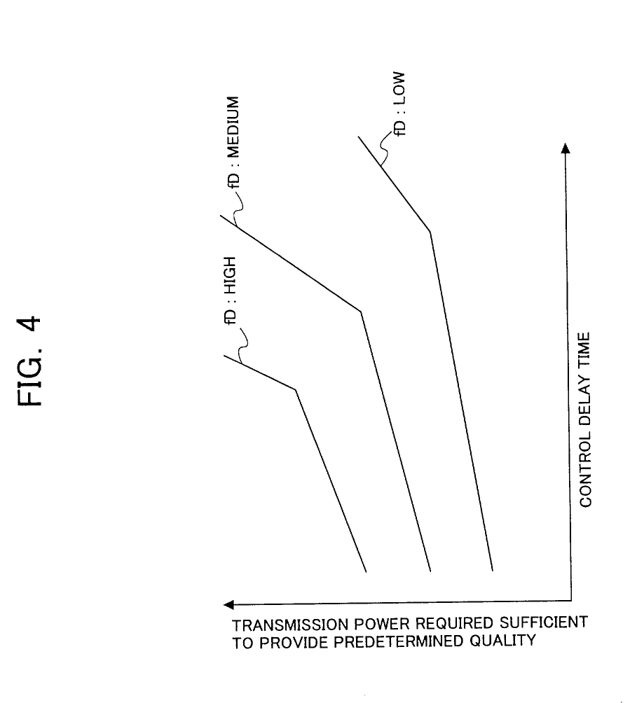

FIG. 4 shows relations between the transmission power required sufficient to predetermined receiving quality and control delay time, with fading frequency being a parameter. Here, the control delay time refers to a time lapse from a point in time when the mobile station 110 determines the averaged receiving quality to a point in time when the base station transmits the downlink time slots contiguously assigned, and a time lapse from a point in time when the base station determines the averaged receiving power to a point in time when the base station 120 transmits the downlink time slots contiguously assigned.

As seen from FIG. 4, the longer the control delay time is, the higher the transmission power is required to attain the predetermined receiving quality at the mobile station 110. That is, the later a time slot in the time slots contiguously assigned is transmitted, the higher transmission power is required. It is also shown that the higher the fading frequency is in the communication between the mobile station 110 and the base station 120, the higher the transmission power is required.

In view of the characteristics shown in FIG. 4, the transmission power setting unit 126 acquires the fading frequency in the communication path between the mobile station 110 and the base station 120 by a predetermined method. Then, the transmission power setting unit 126 sets transmission power of each time slot of the time slots contiguously assigned to be transmitted from the antenna 121-1 such that higher transmission power is set to later time slots, and higher transmission power is set where the fading frequency is higher, based on the characteristic shown in FIG. 4. The transmission power that is set up in this manner is provided to the transceiver unit 122-1.

Similarly, the transmission power setting unit 126 sets transmission power of each time slot of the time slots contiguously assigned to be transmitted from the antenna 121-2 such that higher transmission power is set to later time slots, and higher transmission power is set where the fading frequency is high, based on the characteristic shown in FIG. 4. The transmission power that is set up in this manner is provided to the transceiver unit 122-2.

Here, the transmission power setting unit 126 may be provided with a predetermined initial power value, where the initial power value is adjusted to coincide with the transmission power of each downlink time slot to be transmitted from each of the antennas 121-1 and 121-2 in accordance with the description above.

The antenna 121-1 and the transceiver unit 122-1 transmit at the transmission power set up by the transmission power setting unit 126 for each downlink time slot of the subsequent time slots contiguously assigned. Similarly, the antenna 121-2 and the transceiver unit 122-2 transmit at the transmission power set up by the transmission power setting unit 126 for each downlink time slot of the subsequent time slots contiguously assigned.

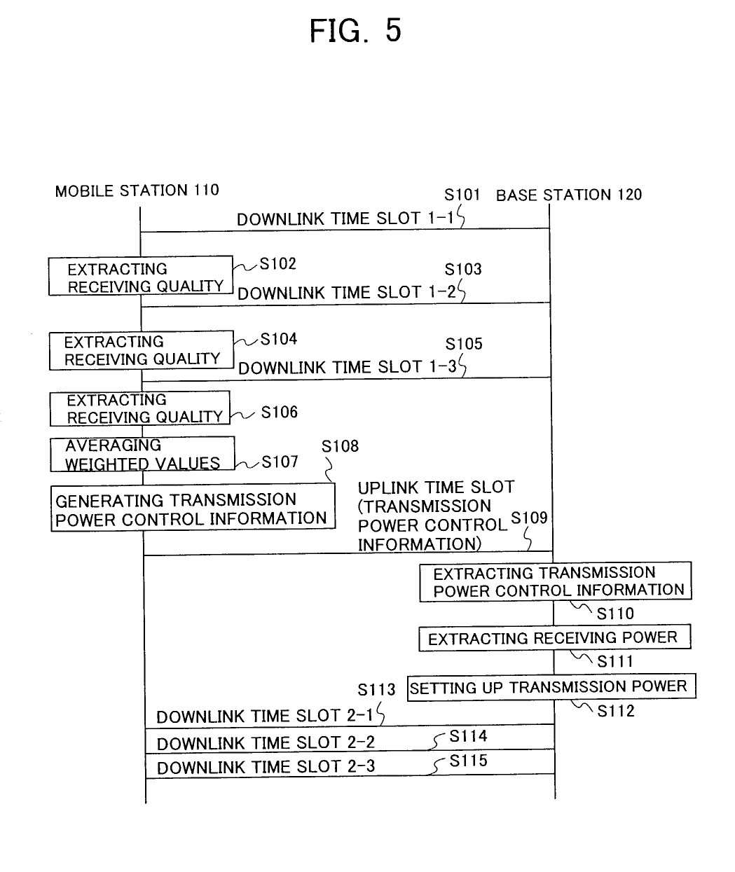

In the following, operations of the mobile station 110 and the base station 120 are explained, referring to the sequence drawing provided in FIG. 5. In FIG. 5, an examples is shown, where one uplink time slot and three downlink time slots that are contiguously provided are assigned.

The base station 120 transmits the three downlink time slots 1-1, 1-2, and 1-3 one by one sequentially through the antennas 121-1 and 121-2 (Steps 101, 103, and 105).

Each time the mobile station 110 receives the three downlink time slots 1-1, 1-2, and 1-3, the mobile station 110 extracts the receiving quality of each of the three time slots (Steps 102, 104, and 106). Then, the mobile station 110 assigns predetermined weight to the receiving quality corresponding to each of the time slots 1-1, 1-2, and 1-3, and extracts the averaged receiving quality (Step 107).

Next, the mobile station 110 generates the transmission power control information as a request for the transmission power of time slots 2-1, 2-2, and 2-3 that are contiguously assigned and to be transmitted next, based on the averaged receiving quality (Step 108). The mobile station 110 modulates the generated transmission power control information by a predetermined method, includes the modulated transmission power control information in an uplink time slot, and transmits the modulated transmission power control information to the base station 120 (Step 109).

The base station 120 extracts the receiving power of the uplink time slot while extracting the transmission power control information from the data acquired by decoding the uplink time slot (Step 110), when the uplink time slot transmitted from the mobile station 110 is received through the antennas 121-1 and 121-2 (Step 111).

Then, the base station 120 sets up the transmission power (Step 112) of each of the downlink time slots 2-1, 2-2, and 2-3 that are to be transmitted next, based on the transmission power control information, the extracted receiving power, and the characteristics shown in FIG. 4, and the time slots are transmitted through each of the antennas 121-1 and 121-2 (Steps 113, 114, and 115).

Although not illustrated, when the mobile station 110 receives the downlink time slots 2-1, 2-2, and 2-3, the mobile station 110 extracts the receiving quality as in steps 102, 104, and 106. Afterwards, operations after step 107 are repeated.

As described above, the mobile communications system 100 sets up the transmission power of the next downlink time slots contiguously assigned based on receiving quality at the mobile station 110 of the current downlink time slots contiguously assigned, receiving power at the base station 120 of the uplink time slot, and the characteristics shown in FIG. 4. The number of the uplink time slots may be one, as the above example took, or larger. In this manner, appropriate transmission power is set up to each of the downlink time slots that are contiguously assigned.

In the above-mentioned embodiments of the mobile station 110, the data quality extracting unit 113 and the receiving power extracting unit 115 correspond to a downlink receiving quality value extracting means, and the data quality averaging unit 114 and the receiving power averaging unit 116 correspond to a receiving quality value averaging means.

In the above-mentioned embodiments of the base station 120, the transmission power setting unit 126 corresponds to a transmission power setting means, the receiving power extracting units 124-1 and 124-2 correspond to an uplink receiving power value extracting means, and the receiving power averaging unit 125 corresponds to an uplink receiving power averaging means.

According to the present invention, suitable transmission power is allocated to each of the downlink time slots that are contiguously assigned for the downlink circuit, based on factors such as average receiving quality of the downlink time slots.

Further, the present invention is not limited to these embodiments, but various variations and modifications may be made without departing from the scope of the present invention.

The present application is based on Japanese priority application No. 2001-319347 filed on Oct. 17, 2001 with the Japanese Patent Office, the entire contents of which are hereby incorporated by reference.

What is claimed is

1. A transmission power setting method of a mobile communications system that employs a TDD method for communications between a base station and a mobile station, wherein a first number of downlink time slots are contiguously assigned to a downlink circuit that carries traffic from the base station to the mobile station, and a second number of uplink time slots are contiguously assigned to an uplink circuit that carries traffic from the mobile station to the base station, where the first number and the second number do not have to be equal, and transmission power of each of said downlink time slots is individually set up, comprising:
the mobile station extracting receiving quality values of all the downlink time slots that are contiguously assigned as a first group,
the mobile station averaging the receiving quality values of all the downlink time slots that are contiguously assigned as the first group, and
the base station setting up transmission power of each of next downlink time slots that are contiguously assigned as a second group, based on the averaged receiving quality value of the downlink time slots that are contiguously assigned as the first group.

2. A transmission power setting method of a mobile communications system that employs a TDD method for communications between a base station that is equipped with a plurality of antennas, each of which is capable of both receiving and transmitting, and a mobile station, wherein a first number of downlink time slots are contiguously assigned to a downlink circuit that carries traffic from the base station to the mobile station, and a second number of uplink time slots are contiguously assigned to an uplink circuit that carries traffic from the mobile station to the base station, where the first number and the second number do not have to be equal, and transmission power of each of said downlink time slots is individually set up, comprising:
the base station extracting a receiving power value of each of the uplink contiguous time slots for each of the antennas,
the base station averaging the receiving power values of the contiguous uplink time slots for each of the antennas, and
the base station setting up for each of the antennas transmission power of each of the downlink time slots that are contiguously assigned and to be transmitted from the base station through each of the antennas based on the averaged receiving power of the uplink time slots.

3. A transmission power setting method of a mobile communications system that employs a TDD method for communications between a base station that is equipped with a plurality of antennas, each of which is capable of both receiving and transmitting, and a mobile station, wherein a first number of downlink time slots are contiguously assigned to a downlink circuit that carries traffic from the base station to the mobile station, and a second number of uplink time slots are contiguously assigned to an uplink circuit that carries traffic from the mobile station to the base station, where the first number and the second number do not have to be equal, and transmission power of each of said downlink time slots is individually set up, comprising:
the mobile station extracting receiving quality values of all the downlink time slots that are contiguously assigned as a first group,
the mobile station averaging the receiving quality values of all the downlink time slots contiguously assigned as the first group,
the base station extracting a receiving power value of each of the contiguous uplink time slots for each of the antennas,
the base station averaging the receiving power values of the contiguous uplink time slots for each of the antennas, and
the base station setting up for each of the antennas transmission power of each of downlink time slots contiguously assigned as a second group, which are to be transmitted from the base station through each of the antennas based on the averaged receiving quality of the first group of the downlink time slots contiguously assigned, and the averaged receiving power of the contiguous uplink time slots.

4. The transmission power setting method as claimed in claim 1, wherein each of the receiving quality values of all the downlink time slots is multiplied with a predetermined weighting factor, and the averaged receiving quality is obtained by averaging the receiving quality values that are weighted.

5. The transmission power setting method as claimed in claim 1, wherein the transmission power of each of the downlink time slots of the second group is set up corresponding to a time lapse from a point in time when the average of the receiving quality values of the first group of the downlink time slots is obtained to a point in time when each of the time slots of the second group is transmitted.

6. The transmission power setting method as claimed in claim 5, wherein an initial transmission power value is predetermined, and the transmission power of each of the downlink time slots of the second group is adjusted from the predetermined initial transmission power value according to a time lapse from a point in time when the average of the receiving quality values of the first group of the downlink time slots is obtained to a point in time when each of the time slots of the second group is transmitted.

7. The transmission power setting method as claimed in claim 2, wherein the averaged receiving power value is obtained by averaging the extracted receiving power values of the uplink time slots that are weighted by a predetermined set of weighting factors.

8. The transmission power setting method as claimed in claim 2, wherein the transmission power for each of the downlink time slots of the second group is set up according to a time lapse from a point in time when the averaged receiving power value is obtained for the uplink time slots to a point in time when each of the downlink time slots of the second group is transmitted.

9. The transmission power setting method as claimed in claim 8, wherein an initial power value is predetermined, the transmission power value is obtained corresponding to the time lapse from the point in time when the averaged receiving power value is obtained for the uplink time slots to the time point when each of the downlink time slots of the second group is transmitted, and the initial power value is adjusted to coincide with the transmission power value.

10. The transmission power setting method as claimed in claim 1, wherein the transmission power of each of the downlink time slots of the second group is set up in accordance with fading frequency in communications between the base station and the mobile station.

11. The transmission power setting method as claimed in claim 10, wherein an initial transmission power is predetermined, and the transmission power of each of the downlink time slots of the second group is obtained by adjusting the initial transmission power in accordance with fading frequency in communications between the base station and the mobile station.

12. A mobile communications system that employs a TDD method for communications between a base station and a mobile station, wherein a first number of downlink time slots are contiguously assigned to a downlink circuit that carries traffic from the base station to the mobile station, and a second number of uplink time slots are contiguously assigned to an uplink circuit that carries traffic from the mobile station to the base station, where the first number and the second number do not have to be equal, and transmission power of each of said downlink time slots is individually set up, comprising:
downlink receiving quality value extracting means provided in the mobile station, for extracting receiving quality values of each of the plurality of downlink time slots that are transmitted as a first group,
downlink receiving quality value averaging means provided in the mobile station, for averaging quality values of the downlink time slots that are contiguously transmitted as the first group, and
transmission power setting means provided in the base station, for setting up transmission power for each of downlink time slots that are to be transmitted as a second group, which are contiguously assigned to the downlink circuit.

13. The mobile communications system as claimed in claim 12, wherein the downlink receiving quality averaging means attaches weight, according to a predetermined set of weighting factors, to each of the downlink receiving quality values of the downlink time slots of the first group, and the downlink receiving quality averaging means averages the downlink receiving quality values that are weighted hereinabove.

14. A mobile communications system as claimed in claim 12, wherein the transmission power setting means sets up the transmission power for each of the downlink time slots that are to be contiguously transmitted as the second group according to a time lapse from a point in time when the average of the receiving quality values of the first group of the downlink time slots is obtained to a point in time when each of the time slots of the second group is transmitted.

15. The mobile communication system as claimed in claim 14, where in the transmission power setting means comprises a predetermined initial transmission power value, and the transmission power of each of the downlink time slots of the second group is adjusted from the predetermined initial transmission power value according to a time lapse from a point in time when the average of the receiving quality values of the first group of the downlink time slots is obtained to a point in time when each of the time slots of the second group is transmitted.

16. A mobile communications system as claimed in claim 12, wherein the base station comprises:
a plurality of antennas, each of which is capable of both receiving and transmitting,
an uplink receiving power value extracting unit that extracts receiving power values of all contiguous uplink time slots for each of the antennas, and
an uplink receiving power averaging unit that averages the receiving power values of the contiguous uplink time slots for each of the antennas, and
the base station sets up for each of the antennas the transmission power of each of the downlink time slots contiguously assigned of the second group that is to be transmitted next from the base station through each of the antennas based on the averaged receiving power value of the contiguous uplink time slots.

17. The mobile communications system as claimed in claim 16, wherein the uplink receiving power averaging means attaches weight, according to a predetermined set of weighting factors, to each of the receiving power values of the uplink time slots, and averages the receiving power values that are weighted hereinabove.

18. The mobile communications system as claimed in claim 16, wherein the transmission power setting means sets up the transmission power for each of the downlink time slots of the second group according to a time lapse from a point in time when the averaged receiving power value is obtained for the uplink time slots to a point in time when each of the downlink time slots of the second group is transmitted.

19. The mobile communications system as claimed in claim 18, wherein the transmission power setting means provides a initial power value that is predetermined, and the transmission power value is obtained according to the time lapse from the point in time when the averaged receiving power value is obtained for the uplink time slots to the time point when each of the downlink time slots of the second group is transmitted, and the initial power value is adjusted to match the transmission power value.

20. The mobile communications system as claimed in claim 12, wherein the transmission power setting means sets up the transmission power of each of the downlink time slots of the second group according to fading frequency of communications between the base station and the mobile station.

21. The mobile communications system as claimed in claim 20, wherein the transmission power setting means provides an initial transmission power value that is predetermined, and the transmission power of each of the downlink time slots of the second group is obtained by adjusting the initial transmission power value in accordance with the fading frequency of the communications between the base station and the mobile station.

22. A base station of a mobile communications system that employs a TDD method for communications with a mobile station, wherein a first number of downlink time slots are contiguously assigned to a downlink circuit that carries traffic from the base station to the mobile station, and a second number of uplink time slots are contiguously assigned to an uplink circuit that carries traffic from the mobile station to the base station, where the first number and the second number do not have to be equal, comprising:
a plurality of antennas, each of which is capable of both receiving and transmitting,
an uplink receiving power value extracting unit that extracts receiving power values of all contiguous uplink time slots for each of the antennas,
an uplink receiving power averaging unit that averages the receiving power values of the contiguous uplink time slots for each of the antennas, and
a transmission power setting unit that sets up transmission power, for each of the antennas, of each of downlink time slots contiguously assigned that are to be transmitted next from the base station through each of the antennas based on the averaged receiving power value of the contiguous uplink time slots.

23. The base station as claimed in claim 22, wherein the uplink receiving power averaging unit attaches weight according to a predetermined set of weighting factors to each of the receiving power values of the uplink time slots, and averages the receiving power values that are weighted hereinabove.

24. The base station as claimed in claim 22, wherein the transmission power setting unit sets up the transmission power for each of the downlink time slots that are to be sent next according to a time lapse from a point in time when the averaged receiving power value is obtained for the uplink time slots to a point in time when each of the downlink time slots that are to be transmitted next.

25. The base station as claimed in claim 24, wherein the transmission power setting unit provides an initial power value that is predetermined, and the transmission power value is obtained according to the time lapse from the point in time when the averaged receiving power value is obtained for the uplink time slots to the time point when each of the downlink time slots that are to be transmitted next is transmitted, and the initial power value is adjusted to coincide with the transmission power value.

26. The base station as claimed in claim 22, wherein the transmission power setting unit sets up the transmission power of each of the downlink time slots that are to be transmitted next according to fading frequency of communications between the base station and the mobile station.

27. The base station as claimed in claim 26, wherein the transmission power setting unit provides an initial transmission power value that is predetermined, and the transmission power of each of the downlink time slots that are to be transmitted next is obtained by adjusting the initial transmission power value in accordance with the fading frequency of the communications between the base station and the mobile station.
